(19) United States
(12) Patent Application Publication
(10) Pub. No.: US 2026/0355797 A1
(43) Pub. Date: Nov. 12, 2026

(54) INDUSTRIAL METHOD AND SYSTEM FOR TURF RECYCLING

(71) Applicants: Robert Delmonico, Rockland, MA (US); Derek Delmonico, Rockland, MA (US)

(72) Inventors: Robert Delmonico, Rockland, MA (US); Derek Delmonico, Rockland, MA (US)

(21) Appl. No.: 19/200,027

(22) Filed: May 6, 2025

(51) Int. Cl. B09B 3/35; B09B 3/40; B09B 101/75; B09B 101/80; B29B 9/06; B29B 17/02; B29B 17/04; B29K 105/26

(52) U.S. Cl. CPC B09B 3/35; B09B 3/40; B29B 17/02; B29B 17/0412; B09B 2101/75; B09B 2101/80; B29B 9/06; B29B 2017/0237; B29K 2105/26

(57) ABSTRACT

The present disclosure relates to an industrial method for recycling turf carpets and a system to perform the method. The turf carpets include synthetic fibers, infill, and a backing. The infill further contains rubber and sand. These parts/materials need to be separated in the recycling process. The method includes: receiving a plurality of turf carpets; removing the infill from the turf carpets; separating the rubber and sand from the infill; separating the synthetic fibers from the backing; pelletizing the synthetic fibers; shredding the backing into pieces. The system includes: a stockpile of turf carpets; an infill processing plant or machine, for separating the infill from the turf carpets and separating the rubber and sand in a pelletizer, for pelletizing the synthetic fibers; and a shredder, for shredding the backing into pieces.

### TECHNICAL FIELD

The present disclosure relates to the fields of recycling and environmental technology.

### BACKGROUND

Turf refers to surfaces made of synthetic fibers that mimic natural grass, commonly used in sports arenas, residential lawns, and commercial settings where natural grass would typically be found. These turfs are typically composed of materials such as rubber, plastic, and sand, all of which can be recycled and resold. However, current recycling technologies do not provide a solution for effective turf recycling. Even when repurposed for secondary applications—such as reusing football field turf for golf courses—it ultimately ends up in a landfill at the end of its lifespan.

Various technologies have been developed to process used turf. Notably, U.S. Pat. No. 11,833,715, which is incorporated herein by reference, discloses a method by Bacchi et al. for recycling the infill of synthetic turf. Bacchi et al. have also developed a method and system for separating turf fibers from their backing. However, no comprehensive solution has been devised to integrate multiple machines and systems into a streamlined process for converting used turf into recycled, resell-able products. The present technology addresses this gap by offering an environmentally friendly, efficient, and cost-effective method for turf recycling.

### SUMMARY

The present disclosure teaches an industrial method for recycling turf carpets, including: receiving a plurality of turf carpets; wherein, the plurality of turf carpets each includes synthetic fibers, infill, and a backing; wherein, the infill comprise rubber and sand; removing the infill from the turf carpets; feeding the infill into a buffer system; separating the rubber and sand from the infill; separating the synthetic fibers from the backing; pelletizing the synthetic fibers; shredding the backing into pieces.

In some embodiments, the turf carpets are cut into uniform-width strips.

In some embodiments, the turf carpets are rolled and stockpiled.

In some embodiments, the synthetic fibers are made from plastic materials.

In some embodiments, the backing is constructed from polypropylene with a polyurethane coating.

In some embodiments, the infill are removed by using an adjustable brush system to dislodge and collect the infill.

In some embodiments, the rubber and sand in the infill are separated based on a difference between their respective densities.

In some embodiments, the presently disclosed method further comprises cleaning and drying the rubber and sand.

In some embodiments, the separation of the synthetic fibers and the backing is performed by shaving off the synthetic fibers from the backing at a base of the synthetic fibers.

In some embodiments, the turf rolls, after the infill are removed, are washed using a high-pressure pump and air-dried.

In some embodiments, the synthetic fibers are densified before the pelletizing of the synthetic fibers.

In some embodiments, the pelletizing of the synthetic fibers includes: shredding or grinding the synthetic fibers into pieces; melting the pieces in an extruder; forcing the melted pieces through a die to form strands; cooling the strands; cutting the cooled strands into uniform pellets.

The present disclosure also teaches industrial system for recycling turf carpets, comprising: a stockpile of turf carpets; wherein, the plurality of turf carpets each includes synthetic fibers, infill, and a backing; wherein, the infill comprise rubber and sand; an infill processing plant, for separating the infill from the turf carpets and separating the rubber and sand in the infill; a clean turf processor, for separating the synthetic fibers from the backing by shaving off the synthetic fibers from the backing at a base of the synthetic fibers; a pelletizer, for pelletizing the synthetic fibers; a shredder, for shredding the backing into pieces.

In some embodiments, the infill processing plant is a fixed system permanently installed at a facility.

In some embodiments, the infill processing plant is a portable system installed on-site.

In some embodiments, the turf carpets are cut into uniform-width strips.

In some embodiments, the infill are removed by using an adjustable brush system of the turf processing plant to dislodge and collect the infill.

In some embodiments, the rubber and sand in the infill are separated based on a difference between their respective densities.

In some embodiments, the infill processing plant includes pumps and air dryers to clean and dry the rubber, sand, and the turf carpets with the infill removed.

In some embodiments, the clean turf processor densifies the synthetic fibers before the synthetic fibers are pelletized.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1 is a cross-sectional side view diagram illustrating a representative structure of a piece of turf carpet.

FIG. 2 is a flow diagram illustrating a method for turf recycling, in accordance with some embodiments of the present disclosure.

FIG. 3 is a diagram illustrating a system for turf recycling, in accordance with some embodiments of the present disclosure.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

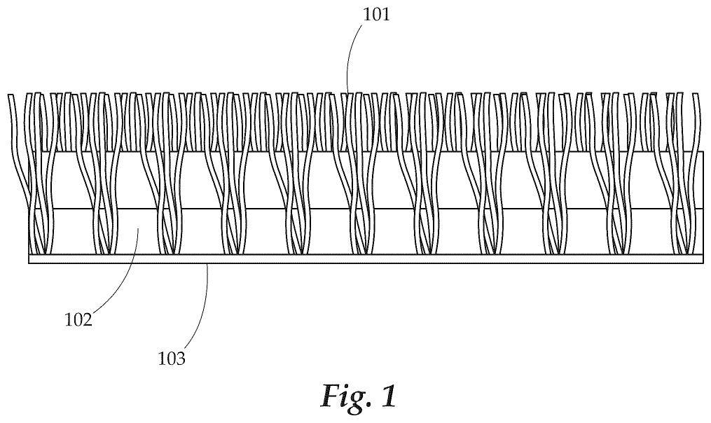

FIG. 1 is a cross-sectional side view diagram illustrating a representative structure of a piece of turf carpet.

Various types of turf carpets are available on the market; however, they generally share the same structural composition. As illustrated in FIG. 1, a typical turf carpet consists of three main components: synthetic fibers 101, infill 102, and 103. Additional layers, such as a shock pad for impact absorption and a base of crushed stone and gravel, may be positioned beneath the backing 103 to complete the turf system. However, these additional layers are not processed by the disclosed method and system, which exclusively handle the synthetic fibers 101, infill 102, and backing 103—collectively referred to as the “turf carpet”, “turf roll” or “carpet roll.”

The synthetic fibers 101 are designed to mimic natural grass and are typically made from plastic materials such as polyethylene, nylon, polypropylene, or combinations of these. To enhance durability, the synthetic fibers 101 may also feature UV-resistant coatings that prevent fading and brittleness. The bottom ends of the synthetic fibers 101 are securely attached to the backing 103, which provides structural support and ensures the fibers remain in place. The backing 103 is commonly made from plastic-based materials or, in some cases, rubber-based materials. In one embodiment, the backing 103 is constructed from polypropylene with a polyurethane coating. Other variations may include backings made from polyester or synthetic rubber. The backing 103 may consist of a single layer or multiple layers.

As shown in FIG. 1, the infill 102 refers to the materials placed between the synthetic fibers to provide support, cushioning, stability, and durability. It functions similarly to soil in natural grass, helping to keep the fibers upright while enhancing the turf's natural feel and performance. The infill 102 may consist of a single layer or multiple layers. Typically, it is composed of rubber granules and sand, but it may also include other materials, such as biodegradable substances or thermoplastic polyurethane (TPU) materials. For the purposes of this disclosure, however, the focus will be primarily on infill made from rubber and sand. A person of ordinary skill in the art would be capable of adapting the disclosed method and system to accommodate infill containing materials other than rubber granules and sand.

When recycling turf carpets, different types of materials may need to be separated from used carpet rolls for resale and reuse. This includes the synthetic fibers 101, infill 102, and backing 103, which may be processed into forms suitable for storage, transportation, and resale. Additionally, the rubber granules and sand in the infill 102 may also need to be separated. As mentioned in the background section, an integrated and streamlined system is crucial for efficiently and economically recycling large volumes of used turf carpets.

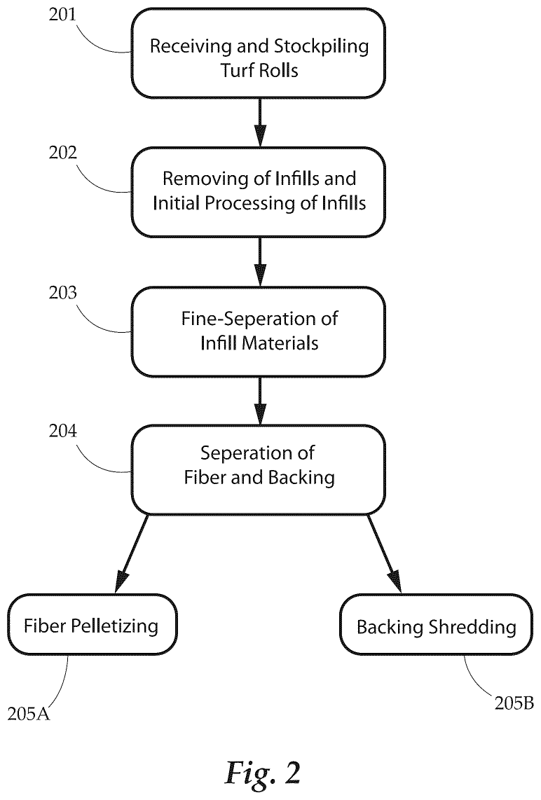

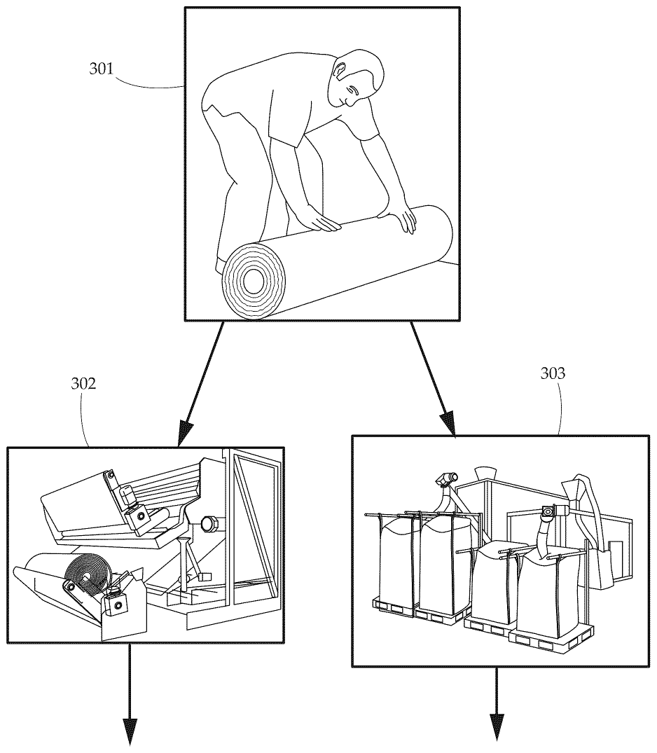

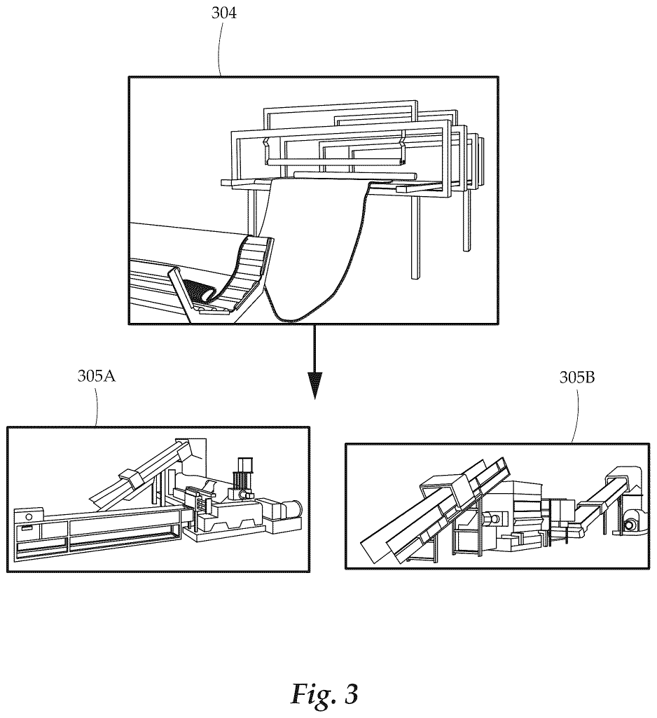

FIG. 2 is a flow diagram illustrating a method for turf recycling, in accordance with some embodiments of the present disclosure. FIG. 3 is a diagram illustrating a system thereof.

In step 201, turf rolls are received and stockpiled. The recycling process begins with the collection of used synthetic turf carpets, which, as described earlier, consist of three main components: synthetic fibers 101, infill 102, and backing 103. As shown in 301, the turf carpets may be cut and rolled up at the field before being transported to a facility for stockpiling and further processing. Alternatively, the turf carpets can be stockpiled on-site, or at landfill locations, and processed using portable machines set up at the location. The carpets are typically cut into uniform-width strips and rolled up for easier transportation, stockpiling, and machine processing. For example, in one embodiment, the strips may be 7.5 feet wide and up to 60 feet long. The size of the strips may be adjusted according to the specifications of the processing machines and transportation equipment, such as forklifts or trucks.

In step 202, the infill 102 is removed from the turf rolls and fed into a buffer system. The buffer system helps maintain a continuous flow of materials through the disclosed system, even if the feeding of infill 102 is inconsistent or temporarily paused. One industrial method for infill removal involves using an adjustable brush system to effectively dislodge and collect the infill. Alternatively, the used turf material may be fed into the system using big bags, a mechanical shovel, or other tools and methods.

In step 203, the components of the infill 102—rubber granules and sand—are separated, cleaned, and dried. As described in the background section, one method for processing infill from turf rolls is detailed in U.S. Pat. No. 11,833,715. This method includes the following steps: drying the infill, screening it through a series of successive screens with passage holes of varying sizes to subdivide the infill into groups of granular materials with different size ranges, separating each group based on the difference in density of the materials, and conveying the separated subgroups to different collection containers. With this process, rubber granules and sand—being granular materials with distinct densities—are effectively separated. Subsequently, the separated materials from the infill may be individually cleaned and dried. Additionally, the infill 102 may contain residues of the synthetic fiber 101, which can also be screened out during the process. In one embodiment, the loose synthetic fiber 101 may be separated from the infill 102 using a specialized dryer in the plant or machine 302/303—and the loose synthetic fiber may be cleaned and sent for further processing at step 305A, to minimize waste.

Relevant patent publications to U.S. Pat. No. 11,833,715, including W.O. 2025/032621, I.T. 2020/00005551, and I.T. 2020/00004087, are also incorporated herein by reference.

Both steps 202 and 203 may be carried out by an infill processing plant 302 or a portable infill processing machine 303. As used herein, the term “infill processing plant” or “infill processing machine” refers to a plant or machine designed to (1) separate infill from turf rolls using an adjustable brush system, and (2) to clean, dry, and segregate the sand and rubber components within the infill material using the method and system disclosed in U.S. Pat. No. 11,833,715. In one embodiment, the infill processing plant 302 may be a large-scale, fixed system permanently installed at a facility. Alternatively, the infill processing machine 303 may be a smaller, portable system designed for the on-site processing of turf rolls. The portable machine 303 may work as a standalone system with its own generator. As mentioned earlier, the infill processing plants or machines 302/303 serve two main purposes: (1) to empty and clean the turf rolls, and (2) to clean, dry, and separate the sand and rubber from the infill materials. Alternatively, steps 202 and 203 may be carried out separately by different machines in ways deemed obvious to a person with ordinary skills in the art.

The infill processing plant 302 may include an adjustable brush system designed to effectively dislodge and collect the infill 102; a buffer system to ensure a continuous flow of materials; an infill processing system for separating rubber and sand in the infill, as disclosed in U.S. Pat. No. 11,833,715 and the related patent applications; and a cleaning and drying system featuring one or more pumps and air dryers to clean and dry the rubber, sand, and clean turfs. In this context, “clean turfs” refers to turf carpets with the infill removed.

In some embodiments, the infill processing plant 302 or machine 303 may process 3 to 8 tons of used turf rolls per hour.

In some embodiments, multiple infill processing plants or machines 302/303 or machines performing the same tasks may be used in parallel to increase the processing capacity and/or speed.

In step 204, after the infill 102 has been removed from the turf rolls, the synthetic fibers 101 are separated from the backing 103. In some embodiments, this step may be performed by one or more clean turf processors 304—as used herein, a “clean turf processor” refers to machines designed to shave off the synthetic fibers 101 from the backing 103 at their base, using rotary or flat blades, similar to a hair-shaving process. The backing 103 may still contain residual synthetic fibers 101, which is acceptable in the process. In one embodiment, the turf rolls (with the infill removed) may be washed using a high-pressure pump and air-dried before cutting to minimize dust residue and prevent contamination. The cut synthetic fibers 101 may also be densified by the clean turf processor 304, or another machine/system. Alternatively, the separation of synthetic fibers 101 from the backing 103 may be carried out using other methods or machinery deemed obvious to a person of ordinary skill in the art. In some embodiments, multiple clean turf processors 304 may be operated in parallel to enhance processing capacity and efficiency.

In step 205A, the synthetic fibers 101 may be pelletized using a pelletizer 305A. Pelletizing refers to the process of compressing or molding a material into pellet form, with a pelletizer serving as the machine that performs this task. This process significantly densifies the loose synthetic fibers, making them easier to store and transport. Moreover, there is a larger recycling market for pellets compared to raw synthetic fibers, which enhances both the financial return for the recycler and the recycling efficiency of the used turf material. The use of a pelletizer 305A in turf recycling was not previously known in the art, nor has it been combined with the steps of processing used turf as described above. In some embodiments, multiple pelletizers 305A may be operated in parallel to enhance processing capacity and efficiency.

In some embodiments, the pelletizing process may include the following steps: shredding and/or grinding the synthetic fibers 101 into small pieces; melting the pieces in an extruder; forcing the molten material through a die to form long strands; cooling the strands, either in a water bath or by air cooling, to solidify them; and cutting the cooled strands into uniform pellets.

In Step 205B, the backing 103 is shredded into smaller pieces using a rubber shredder, granulator, or dual-shaft shredder 305B. In some embodiments, the shredder 305B may be integrated as part of the clean turf processor 304. Additionally, in some embodiments, the backing 103 may undergo further grinding using a grinder. Similar to the pelletizing process, shredding the backing 103 into smaller pieces aids in the efficient storage and transportation of the material. In some embodiments, multiple shredders 305B may be operated in parallel to enhance processing capacity and efficiency.

In some embodiments, one or more of the machines discussed above, including the infill processing plant 302 or machine 303, the clean turf processors 304, the pelletizer 305A, and the shredder 305B, may be integrated into a single machine or system.

In some embodiments, the pellets produced in Step 205A and the shredded backing 103 obtained in Step 205B may be packed and sold in respective markets for recycled materials.

In some embodiments, transportation of materials between machines and/or worksites may be performed using forklifts, conveyors, carts, trolleys, automated vehicles, or other transport mechanisms.

In some embodiments, the presently disclosed method/system may process up to 10 tons of turf carpets per hour.

Furthermore, unless explicitly stated in the claims, the use of order, numbers, letters, or other names for processing elements and sequences are not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of ±20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. An industrial method for recycling turf carpets, including:
receiving a plurality of turf carpets;
wherein, the plurality of turf carpets each includes synthetic fibers, infill, and a backing;
wherein, the infill comprise rubber and sand;
removing the infill from the turf carpets;
feeding the infill into a buffer system;
separating the rubber and sand from the infill;
separating the synthetic fibers from the backing;
pelletizing the synthetic fibers;
shredding the backing into pieces.

2. The industrial method of claim 1, wherein the turf carpets are cut into uniform-width strips.

3. The industrial method of claim 1, wherein the turf carpets are rolled and stockpiled.

4. The industrial method of claim 1, wherein the synthetic fibers are made from plastic materials.

5. The industrial method of claim 1, wherein the backing is constructed from polypropylene with a polyurethane coating.

6. The industrial method of claim 1, wherein the infill are removed by using an adjustable brush system to dislodge and collect the infill.

7. The industrial method of claim 1, wherein the rubber and sand in the infill are separated based on a difference between their respective densities.

8. The industrial method of claim 1, further comprising cleaning and drying the rubber and sand.

9. The industrial method of claim 1, wherein the separation of the synthetic fibers and the backing is performed by shaving off the synthetic fibers from the backing at a base of the synthetic fibers.

10. The industrial method of claim 1, wherein the turf rolls, after the infill are removed, are washed using a high-pressure pump and air-dried.

11. The industrial method of claim 1, wherein the synthetic fibers are densified before the pelletizing of the synthetic fibers.

12. The industrial method of claim 1, wherein the pelletizing of the synthetic fibers includes:
shredding or grinding the synthetic fibers into pieces;
melting the pieces in an extruder;
forcing the melted pieces through a die to form strands;
cooling the strands;
cutting the cooled strands into uniform pellets.

13. An industrial system for recycling turf carpets, comprising:
a stockpile of turf carpets;
wherein, the plurality of turf carpets each includes synthetic fibers, infill, and a backing;
wherein, the infill comprise rubber and sand;
an infill processing plant or machine, for separating the infill from the turf carpets and separating the rubber and sand in the infill;
a clean turf processor, for separating the synthetic fibers from the backing by shaving off the synthetic fibers from the backing at a base of the synthetic fibers;
a pelletizer, for pelletizing the synthetic fibers;
a shredder, for shredding the backing into pieces.

14. The industrial system for recycling turf carpets of claim 13, wherein the infill processing plant or machine is a fixed system permanently installed at a facility.

15. The industrial system for recycling turf carpets of claim 13, wherein the infill processing plant or machine is a portable system installed on site.

16. The industrial system for recycling turf carpets of claim 13, wherein the turf carpets are cut into uniform-width strips.

17. The industrial system for recycling turf carpets of claim 13, wherein the infill is removed by using an adjustable brush system of the infill processing plant or machine to dislodge and collect the infill.

18. The industrial system for recycling turf carpets of claim 13, wherein the rubber and sand in the infill are separated based on a difference between their respective densities.

19. The industrial system for recycling turf carpets of claim 13, wherein the infill processing plant or machine includes pumps and air dryers to clean and dry the rubber, sand, and the turf carpets with the infill removed.

20. The industrial system for recycling turf carpets of claim 13, wherein the clean turf processor densifies the synthetic fibers before the synthetic fibers are pelletized.
